(19) United States
(12) Patent Application Publication
(10) Pub. No.: US 2018/0326916 A1
(43) Pub. Date: Nov. 15, 2018

(54) ROOF RAIL SYSTEM

(71) Applicant: Dura Operating, LLC, Auburn Hills, MI (US)

(72) Inventor: Cumhur Unveren, Walled Lake, MI (US)

(21) Appl. No.: 15/976,145

(22) Filed: May 10, 2018

Related U.S. Application Data
(60) Provisional application No. 62/504,163, filed on May 10, 2017.

(51) Int. Cl. B60R 9/05

(52) U.S. Cl. CPC B60R 9/05

(57) ABSTRACT

According to several aspects, a roof rail system for a vehicle includes a stanchion connected to a roof surface of a motor vehicle at a vehicle attachment portion and connected to a roof rail at a roof rail attachment portion. The stanchion has an outer surface, an inner surface, a leading and a trailing surface. The inner surface has a recessed portion, and an inlet hole and an outlet hole for receiving a load securing member. The stanchion is aerodynamically optimized to improve drag and wind-noise characteristics.

### CROSS-REFERENCE TO RELATED APPLICATIONS

This application is a continuation of prior U.S. Provisional Application Ser. No. 62/504,163 filed on May 10, 2017. The entire disclosure of the above application is hereby incorporated by reference.

### FIELD

The present disclosure relates generally to motor vehicle roof rails, and to more particularly to roof rail tie down attachment systems and features.

### BACKGROUND

The statements in this section merely provide background information related to the present disclosure and may or may not constitute prior art.

Typical roof rail systems for motor vehicles typically include a stanchion which connects to the vehicle roof to space a roof rail or cross bar away from the vehicle roof. Roof rail systems carry objects such as luggage, materials, recreational equipment or storage on the roof of the motor vehicle. Frequently, roof rail systems use specially designed fasteners or conventional load securing devices to attach objects to the roof rails. Stanchions and roof rails and cross bars are preferably designed aerodynamically to reduce drag and prevent noises such as whistling and buffeting while driving. Specially designed fasteners or conventional load securing devices are often not aerodynamically efficient, and can cause whistling, buffeting or other noises while driving. Thus, while current roof rail systems achieve their intended purpose, there is a need for a new and improved roof rail design with a stanchion having an integrated load securing portion with improved aerodynamic characteristics and performance.

### SUMMARY

According to several aspects a roof rail system for a motor vehicle includes a stanchion extending away from a roof surface of the motor vehicle, the stanchion connected to the roof surface at a vehicle attachment portion. The stanchion having an outer surface facing outward from the motor vehicle, the outer surface connected to and extending from a leading surface to a trailing surface. The leading surface oriented towards a front of the motor vehicle, and the trailing surface disposed opposite the leading surface and facing towards a rear of the motor vehicle. The stanchion having an inner surface facing inward relative to the motor vehicle, the inner surface connected to and extending from the leading surface to the trailing surface, the inner surface disposed opposite the outer surface, and the inner surface having a first recessed portion with a load securing portion integrally formed therein. The load securing portion is disposed behind the leading surface relative to the front of the motor vehicle.

In another aspect of the present disclosure the stanchion extends from the vehicle attachment portion to a cross bar attachment portion

In yet another aspect of the present disclosure the stanchion has a generally tapering cross section. The stanchion has a local maximum cross sectional width proximate the leading surface, and a local minimum cross sectional width proximate the trailing surface.

In yet another aspect of the present disclosure the stanchion has a generally tapering cross sectional width. The stanchion has a local maximum cross sectional width at the vehicle attachment portion proximate the roof surface of the motor vehicle, and a local minimum cross sectional width proximate the cross bar attachment portion.

In yet another aspect of the present disclosure each of the outer surface, the leading surface, and the trailing surface has a generally smooth, curvilinear shape.

In yet another aspect of the present disclosure the stanchion is aerodynamically optimized to reduce aerodynamic drag, turbulence, vortices, and wind-noise.

In yet another aspect of the present disclosure the load securing portion further comprises an inlet hole connected by a curvilinear bore to an outlet hole.

In yet another aspect of the present disclosure the inlet hole is disposed within the first recessed portion in an area behind the leading surface, and the outlet hole is disposed in a second recessed portion positioned forward of the trailing surface.

In yet another aspect of the present disclosure the inlet hole is oriented substantially vertically, and the outlet hole faces substantially towards the rear of the motor vehicle, and the outlet hole is oriented substantially horizontally, and parallel to the roof surface.

In yet another aspect of the present disclosure the inlet hole is oriented substantially horizontally and parallel to the roof surface, and wherein the outlet hole is oriented substantially horizontally and parallel to the roof surface.

In yet another aspect of the present disclosure the inlet hole and the outlet hole are oriented between about 90° and 135° relative to one another.

In yet another aspect of the present disclosure the roof rail system further includes a fairing forming an aerodynamically efficient outer covering for the inner surface, the outer surface, and the leading surface of the stanchion.

In yet another aspect of the present disclosure a roof rail system for a motor vehicle includes a stanchion extending away from a roof surface of the motor vehicle, the stanchion connected to the roof surface at a vehicle attachment portion, and extending away from the roof surface to a cross bar attachment portion. The stanchion has an outer surface facing outward from the motor vehicle, the outer surface is connected to and extending from a leading surface to a trailing surface. The leading surface is oriented towards a front of the motor vehicle, and the trailing surface is disposed opposite the leading surface and faces towards a rear of the motor vehicle. The stanchion further includes an inner surface facing inward relative to the motor vehicle, the inner surface connected to and extending from the leading surface to the trailing surface, the inner surface is disposed opposite the outer surface, and the inner surface has a first recessed portion with a load securing portion integrally formed therein. The stanchion has a fairing forming an aerodynamically efficient outer covering for the inner surface, the outer surface, and the leading surface of the stanchion. The stanchion has a generally tapering cross section with a local maximum cross sectional width proximate the leading surface, and a local minimum cross sectional width proximate the trailing surface, the stanchion having a local maximum cross sectional width at the vehicle attachment portion proximate the roof surface of the motor vehicle, and a local minimum cross sectional width proximate the cross bar attachment portion, the load securing portion is disposed behind the leading surface relative to the front of the motor vehicle.

In yet another aspect of the present disclosure each of the outer surface, the leading surface, and the trailing surface has a generally smooth, curvilinear shape.

In yet another aspect of the present disclosure the stanchion is aerodynamically optimized to reduce aerodynamic drag, turbulence, vortices, and wind-noise.

In yet another aspect of the present disclosure the load securing portion further comprises an inlet hole connected by a curvilinear bore to an outlet hole.

In yet another aspect of the present disclosure the inlet hole is disposed within the first recessed portion in an area behind the leading surface, and the outlet hole is disposed in a second recessed portion positioned forward of the trailing surface.

In yet another aspect of the present disclosure the inlet hole is oriented substantially vertically and substantially perpendicular to the roof surface, and the outlet hole faces substantially towards the rear of the motor vehicle, and the outlet hole is oriented substantially horizontally, and parallel to the roof surface.

In yet another aspect of the present disclosure the inlet hole is oriented substantially horizontally and parallel to the roof surface, and the outlet hole faces substantially laterally across the motor vehicle and is oriented substantially horizontally, and parallel to the roof surface.

In yet another aspect of the present disclosure a roof rail system for a motor vehicle includes a plurality of aerodynamically optimized stanchions extending away from a roof surface of the motor vehicle, the stanchions connected to the roof surface at a vehicle attachment portion, and extending away from the roof surface to a cross bar attachment portion. The roof rail system further includes a plurality of cross bars attached to the plurality of stanchions at the cross bar attachment portion of each of the stanchions. Each of the stanchions has a substantially smooth, curvilinear outer surface facing outward from the motor vehicle, the outer surface connected to and extending from a substantially smooth, curvilinear leading surface to a substantially smooth, curvilinear trailing surface. The leading surface is oriented towards a front of the motor vehicle, and the trailing surface is disposed opposite the leading surface and faces towards a rear of the motor vehicle. Each of the stanchions further includes an inner surface facing inward relative to the motor vehicle, the inner surface is connected to and extends from the leading surface to the trailing surface. The inner surface is disposed opposite the outer surface, and the inner surface has a first recessed portion with a load securing portion integrally formed therein. The load securing portion has an inlet hole connected by a curvilinear bore to an outlet hole disposed in a second recessed portion of the inner surface. The inlet hole is disposed within the first recessed portion in an area behind the leading surface, and the outlet hole is disposed in a second recessed portion positioned forward of the trailing surface. The stanchion has a generally tapering cross section with a local maximum cross sectional width proximate the leading surface, and a local minimum cross sectional width proximate the trailing surface, the stanchion having a local maximum cross sectional width at the vehicle attachment portion proximate the roof surface of the motor vehicle, and a local minimum cross sectional width proximate the cross bar attachment portion. The load securing portion is disposed behind the leading surface relative to the front of the motor vehicle, and each of the stanchions has a fairing forming an aerodynamically efficient outer covering for the inner surface, the outer surface, and the leading surface of the stanchions.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. In the drawings:

FIG. 1 is an exterior top view of a motor vehicle equipped with a roof rail system according to an aspect of the present disclosure;

FIG. 2A is an interior rear perspective view of a roof rail system according to an aspect of the present disclosure;

FIG. 2B is an interior front perspective view of a roof rail system according to an aspect of the present disclosure;

FIG. 2C is a perspective rear view of a roof rail system according to an aspect of the present disclosure;

FIG. 3A is an exterior front perspective view of a roof rail system according to an aspect of the present disclosure;

FIG. 3B is a perspective rear view of a roof rail system according to an aspect of the present disclosure;

FIG. 3C is an exploded interior rear perspective view of a roof rail system according to an aspect of the present disclosure;

FIG. 4A is a perspective exterior side view of a portion of a roof rail system according to an aspect of the present disclosure;

FIG. 4B is a perspective exterior side view of a portion of a roof rail system according to an aspect of the present disclosure;

FIG. 4C is a perspective exterior side view of a portion of a roof rail system according to an aspect of the present disclosure; and

FIG. 4D is a perspective exterior side view of a portion of a roof rail system according to an aspect of the present disclosure.

### DETAILED DESCRIPTION

The following description is merely exemplary in nature and is not intended to limit the present disclosure, application, or uses.

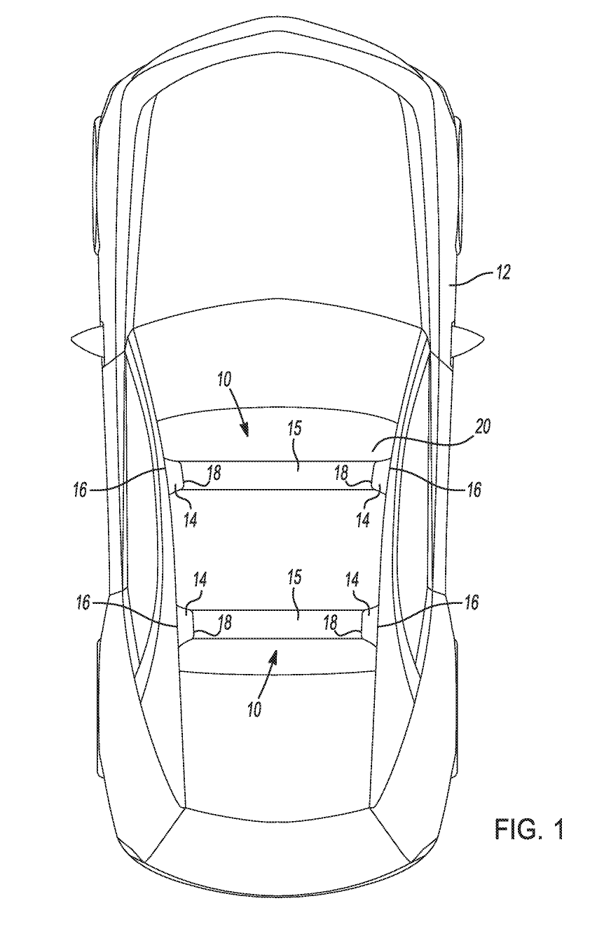

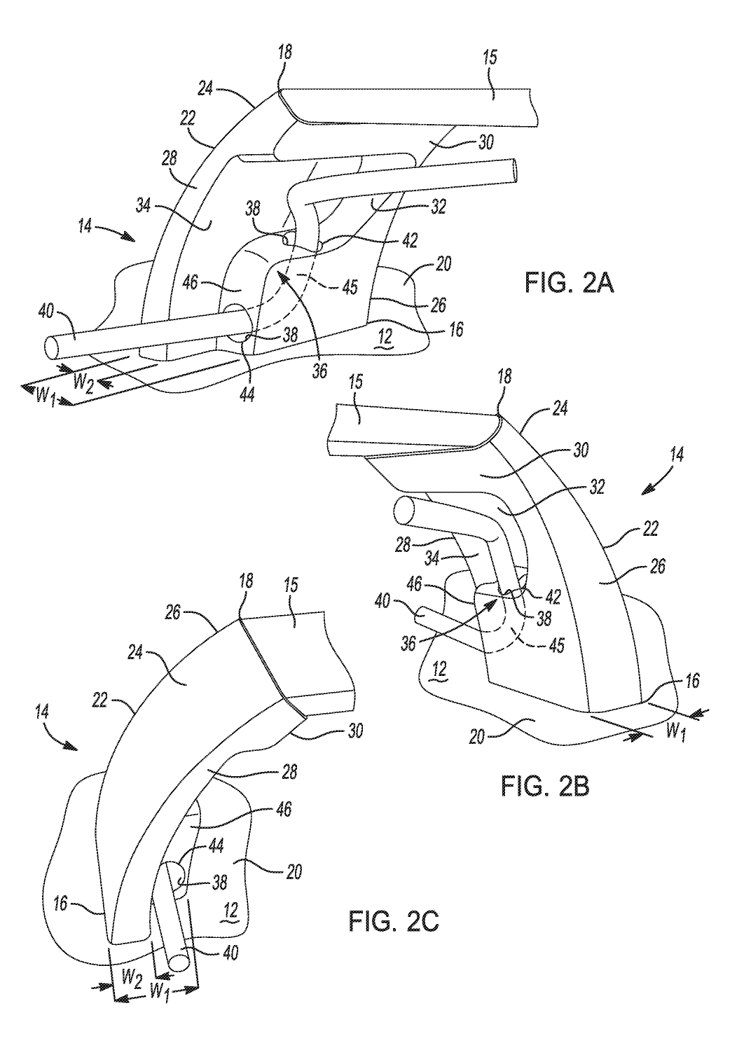

Referring to FIGS. 1-2C, a first example of a roof rail system according to the present disclosure is shown and generally indicated by reference number 10. The roof rail system 10 is preferably used with a motor vehicle 12, for example a passenger vehicle, truck, sport utility vehicle, van, motor home, or any other type of vehicle without departing from the scope of the present disclosure. The roof rail system 10 generally includes a plurality of stanchions 14, and a cross bar 15. For simplicity, in the description that follows while only a single stanchion 14 may be described in detail, it should be understood that the roof rail system 10 includes at least two stanchions 14 disposed on the vehicle 12 to support a roof rail and/or cross bar. For example, the at least two stanchions 14 may be disposed on left and right-hand sides of the vehicle 12 with a cross bar 15 disposed between the two stanchions 14. In another example, the at least two stanchions 14 may be disposed on front and rear sides of the vehicle 12 with a longitudinally oriented roof rail (not shown) disposed between the two stanchions 14.

The stanchion 14 has a vehicle attachment portion 16 and a cross bar attachment portion 18. The stanchion 14 extends outwardly from a roof surface 20 of the vehicle 12 from the vehicle attachment portion 16 to the cross bar attachment portion 18 with a central portion 22 disposed therebetween. The vehicle attachment portion 16 is mounted to the vehicle 12 using attachment points (not shown) provided on the vehicle 12. In one aspect, the vehicle attachment portion 16 may be mounted to the vehicle 12 by a variety of different attachment mechanisms including: adhesives, welds, mechanical fasteners, such as screws, bolts, clips, rivets and the like. In some aspects, the vehicle attachment portion 16 may be slidably mounted and in locking engagement with a portion of the roof surface 20 of the vehicle 12. In one aspect, the cross bar attachment portion 18 is attached to the cross bar 15 by a variety of different attachment features (not shown) including: welds, mechanical fasteners such as screws, bolts, clips, rivets, and the like. In some aspects, the cross bar 15 may be slidably mounted in a locking interface with the cross bar attachment portion 18 of the stanchion 14.

The central portion 22 has an outboard surface 24, a leading surface 26, a trailing surface 28, and an inboard surface 30. The outboard surface 24 extends from the roof surface 20 of the vehicle 12 to the cross bar attachment portion 18 and forms an exterior aspect of the central portion 22 of the stanchion 14. In one aspect, the outboard surface 24 of the central portion 22 of the stanchion 14 is oriented to face outward relative to a longitudinal axis of the vehicle 12. The outboard surface 24 is designed to be aesthetically pleasing to operators of the vehicle 12, and has a generally smooth, curvilinear shape. The outboard surface 24 also extends from the leading surface 26 to the trailing surface 28 of the central portion 22 of the stanchion 14.

The leading surface 26 forms the forward-most surface of the central portion 22 of the stanchion 14. The leading surface 26 extends from the roof surface 20 of the vehicle 12 to the cross bar attachment portion 18, and is aerodynamically designed. In several aspects, the leading surface 26 is aerodynamically optimized to minimize aerodynamic drag, turbulence, wind noise and the like. The leading surface 26 defines a first width “W₁” between the outboard surface 24 and the inboard surface 30. More particularly leading surface 26 extends from the outboard surface 24 to an inboard edge 32. The inboard edge 32 also forms the forward-most aspect of the inboard surface 30. In one aspect, the first width “W₁” of the leading surface 26 is variable. For example, the first width “W₁” may be greater at the roof surface 20 of the vehicle 12 than at the cross bar attachment portion 18. The leading surface 26 is designed to be aesthetically pleasing to operators of the vehicle 12, and has a generally smooth, curvilinear shape.

The trailing surface 28 forms the rearward-most surface of the central portion 22 of the stanchion 14. The trailing surface 28 extends from the roof surface 20 of the vehicle 12 to the cross bar attachment portion 18, and is aerodynamically designed. The trailing surface 28 defines a second width “W₂” between the outboard surface 24 and the inboard surface 30. In one aspect, the second width “W₂” of the trailing surface 28 is variable. For example, the second width “W₂” may be greater at the roof surface 20 of the vehicle 12 than at the cross bar attachment portion 18. Furthermore, the second width “W₂” may be the same as or smaller than the first width “W₁” of the leading surface 26. When the second width “W₂” is smaller than the first width “W₁”, the central portion 22 of the stanchion 14 has a generally tapering cross section. In several aspects, the trailing surface 28 is aerodynamically optimized to minimize aerodynamic drag, turbulence, vortices, wind noise, and the like. The trailing surface 28 is also designed to be aesthetically pleasing to operators of the vehicle 12, and has a generally smooth, curvilinear shape.

The inner or inboard surface 30 extends from the roof surface 20 of the vehicle 12 to the cross bar attachment portion 18 and forms an interior aspect of the central portion 22 of the stanchion 14. In one aspect, the inboard surface 30 of the central portion 22 of the stanchion 14 is oriented to face inward toward the longitudinal axis of the vehicle 12. That is, the inboard surface 30 is disposed opposite the outboard surface 24 of the central portion 22. The inboard surface 30 is aerodynamically optimized to minimize aerodynamic drag, turbulence, vortices, wind noise, and the like. The inboard surface 30 has a generally smooth, curvilinear shape. The inboard surface 30 also extends from the leading surface 26 to the trailing surface 28 of the central portion 22 of the stanchion 14. Inboard surface 30 further includes a first recessed area 34. The first recessed area 34 is disposed behind the leading surface 26, and recessed from smooth, curvilinear shape of the inboard surface 30 and the inboard edge 32 of the leading surface 26.

In several aspects, the stanchion 14 may include a transition between the outboard surface 24 and the leading surface 26, and/or between the outboard surface 24 and the trailing surface 28. Similarly the stanchion 14 may include a transition between the inboard surface 30 and the leading surface 26, and/or between the inboard surface 30 and the trailing surface 28. The transition may have a corner, a chamfer, a radius, or other geometry connecting the outboard, leading, trailing, and inboard surfaces 24, 26, 28, 30 as described hereinabove.

A load securing portion 36 is integrally formed in the central portion 22 of the stanchion 14. The load securing portion 36 is positioned behind the leading surface 26, and is a continuation of a portion of the inboard edge 32. The load securing portion 36 includes attachment features 38 for receiving a fastener 40, such as a rope, cable, bungee, hook, clip, or the like. In one aspect, the attachment features 38 include an inlet hole 42 and an outlet hole 44. The inlet hole 42 is located in an area behind the leading surface 26 and within the first recessed area 34. The outlet hole 44 is located in an area behind the leading surface 26. The inlet hole 42 and outlet hole 44 are connected by a curvilinear bore 45 through a portion of the central portion 22 of the stanchion 14. In one aspect, the inlet hole 42 is vertically oriented in the load securing portion 36, and the outlet hole is horizontally oriented in the load securing portion 36. Thus, the curvilinear bore 45 traverses an internal aspect of the central portion 22. In one aspect, the inlet and outlet holes 42, 44 are oriented at approximately 90°-135° relative to one another. The inboard surface 30 further includes a second recessed area 46 positioned forward of the trailing surface 28. In one aspect, the outlet hole 44 is located in the second recessed area 46, and faces towards the rear of the vehicle 12.

The placement and orientation of the inlet hole 42 and the outlet hole 44 are optimized for ease of use, structural integrity, and low wind noise and turbulence characteristics. For example, when the vehicle 12 is in motion, there is a potential for the inlet hole 42 and/or outlet hole 44 to resonate. That is, when air flows over the inlet hole 42 and/or outlet hole 44, one, the other, or both may create audible noise, such as a whistling sound. In order to reduce the potential for whistling noises to emanate from the inlet and outlet holes 42, 44, the inlet and outlet holes 42, 44 are disposed within the first and second recessed areas 34, 46. More particularly, the leading surface 26 of the central portion 22 of the stanchion 14 directs airflow around the inlet hole 42 and outlet hole 44 so that the potential for undesirable audible noise is decreased.

Moreover, because the integrally formed load securing portion 36 is formed on the inboard surface 30 of the central portion 22 of the stanchion 14, the load securing portion 36, and the inlet hole 42 and outlet hole 44 are hidden from view when an individual is looking at the outboard surface 24. In one aspect, because the load securing portion 36, inlet hole 42, and outlet hole 44 are hidden from view, the roof rail attachment system 10 has an aesthetically smooth, and pleasing design.

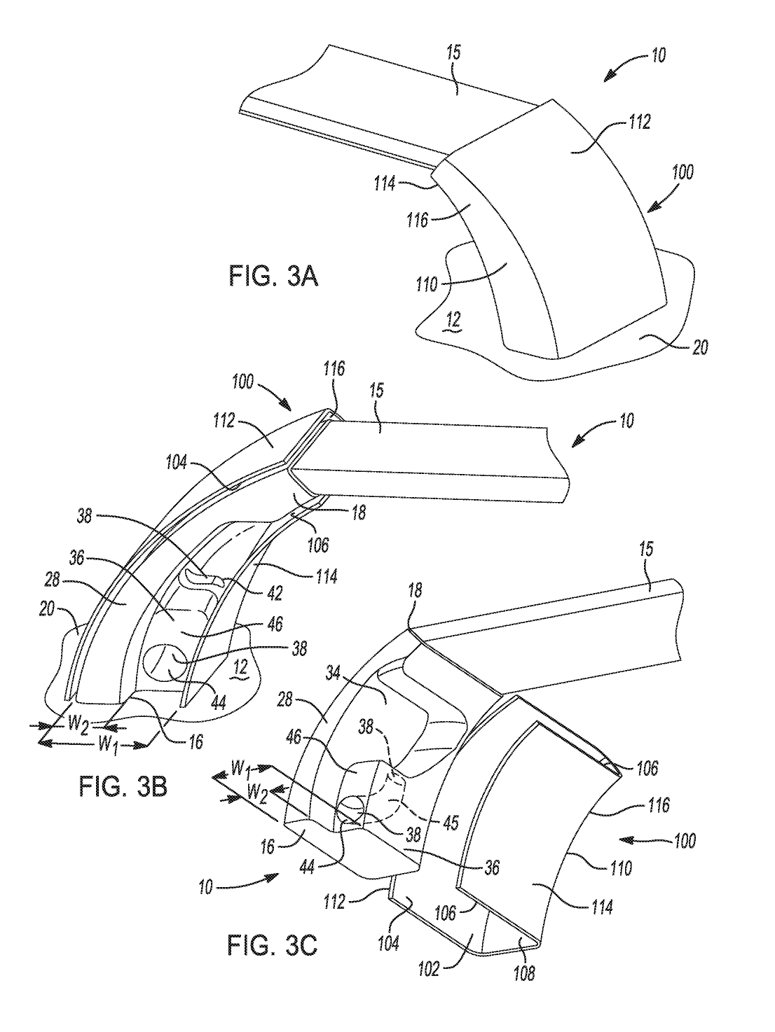

Referring now to FIGS. 3A-3C and with continuing reference to FIGS. 1-2C an alternate embodiment of the roof rail system 10 is shown. The roof rail system 10 of FIGS. 3A-3C is generally similar to the roof rail system 10 of FIGS. 1-2C, except for the addition of a fairing, generally indicated by reference number 100, otherwise like components are indicated by like reference numbers. The fairing 100 forms an aerodynamically efficient outer covering for the stanchion 14. The fairing 100 has a generally u-shaped cross section sized to engage with and fit over the stanchion 14. In one aspect, the fairing 100 is installed onto the stanchion 14 by the manufacturer and is not removable by an operator of the vehicle 12. In another aspect, the fairing 100 can be removed from the stanchion 14 so that an operator of the vehicle 12 may increase his or her ease of access to the load securing portion 36, inlet hole 42, and outlet hole 44. The fairing 100 may be affixed to the stanchion 14 in a variety of ways such as press fit connections, clips, snaps, bolts, screws, magnetic connectors, adhesives, and the like without departing from the scope or intent of the present disclosure.

The fairing 100 has an interior surface 102, defined by an exterior section 104 connected to an interior section 106 by a front section 108. When placed on and engaged with the stanchion 14, the interior surface 102 of the fairing 100 is in physical contact with, and engages with the outboard surface 24, leading surface 26, and inboard surface 30 of the central portion 22 of the stanchion 14. More specifically, the exterior section 104 is inward-facing relative to the longitudinal axis of the vehicle 12, and is in contact with and engages with substantially with the entirety of the outboard surface 24. The front section 108 is rearward facing relative to the longitudinal axis of the vehicle 12 and is in contact with and engages with substantially the entirety of the leading surface 26. The interior section 106 is outward-facing relative to the longitudinal axis of the vehicle 12 and is in contact with and engages substantially the entirety of the inboard surface 30. Thus, the exterior section 104 extends substantially from the leading surface 26 to the trailing surface 28, and from the roof surface 20 to the cross bar attachment portion 18 in parallel with the outboard surface 24 of the central portion 22. Similarly, the interior section 106 extends substantially from the leading surface 26 to the trailing surface 28 and from the roof surface 20 to the cross bar attachment portion 18 in parallel with the inboard surface 30 of the central portion 22. Likewise, the front section 108 of the fairing 100 extends substantially over the leading surface 26 from the roof surface 20 to the cross bar attachment portion 18 in parallel with the leading surface 26. Thus, because at the trailing surface 28 the second width “W₂” of the central portion 22 is smaller than the first width “W₁” of the leading surface 26, the central portion 22 of the stanchion 14 has a generally tapering cross section. Therefore, in order for the fairing 100 to engage with and contact both the outboard surface 24 and the inboard surface 30 of the central portion 22, the generally u-shaped fairing 100 has a similarly tapering cross-section from the front section 108 towards the rear of the vehicle 12.

The fairing 100 also has an exterior surface 110 with an exterior portion 112 connected to an interior portion 114 by a front portion 116. The exterior portion 112 parallels the exterior section 104 but is outward-facing relative to the longitudinal axis of the vehicle 12. The interior portion 114 parallels the interior section 106, but is inward-facing relative to the longitudinal axis of the vehicle 12. The front portion 116 parallels the front section 108, but is forward-facing relative to the longitudinal axis of the vehicle 12. The exterior portion 112, interior portion 114, and front portion 116 each extend from the roof surface 20 to the cross bar attachment portion 18 and have a smooth curvilinear shape that is aesthetically pleasing and aerodynamically optimized to reduce drag, wind-noise, and the like.

Like the stanchion 14, the fairing 100 may include a transition between the exterior portion 112, and the front portion 116, and between the front portion 116 and the interior portion 114. The transition may have a corner, a chamfer, a radius, or other geometry connecting the exterior, interior, and front portions 112, 114, 116 as described hereinabove.

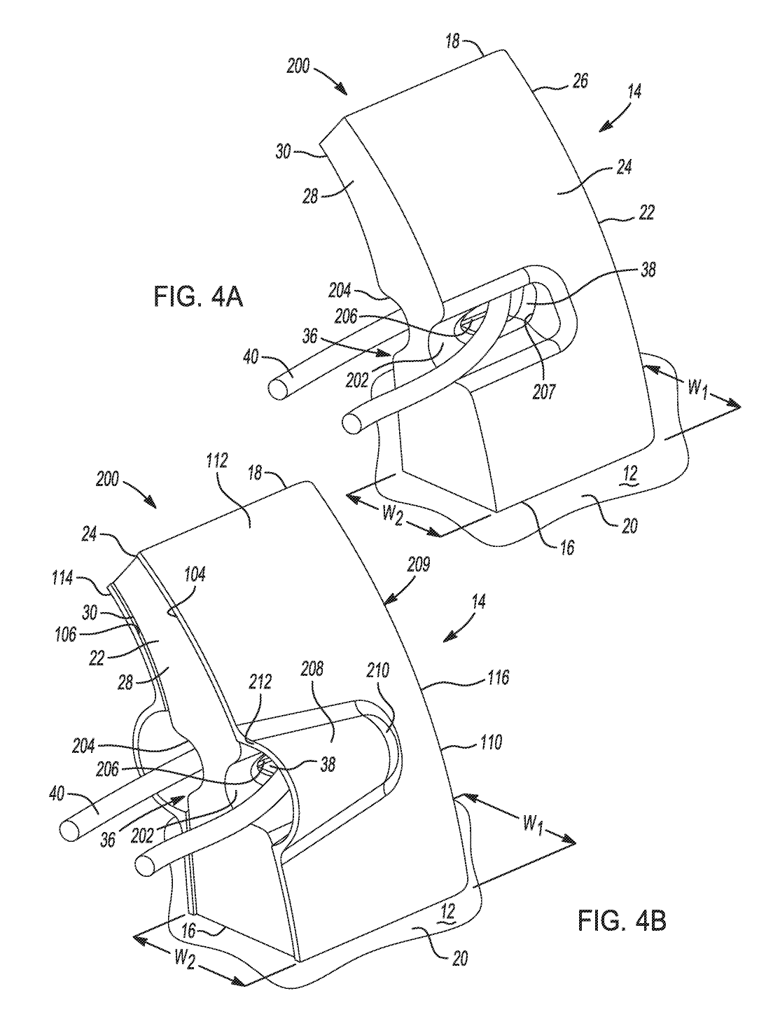

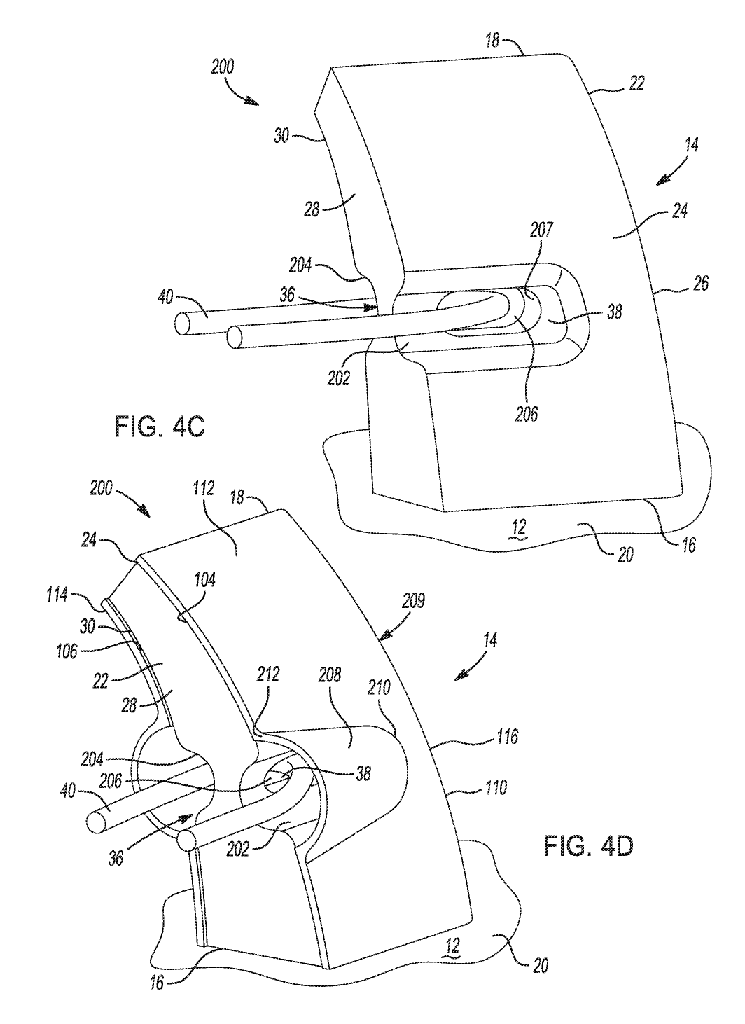

Referring now to FIGS. 4A-4D, and with continuing reference to FIGS. 1-3C, an alternate embodiment of a roof rail system is shown. The roof rail system 200 of FIGS. 4A-4D is generally similar to the roof rail system 10 of FIGS. 1-3C except for the locations and orientations of the inlet and outlet holes 42, 44, and certain features of the fairing 100, otherwise like components are indicated by like reference numbers.

Like the embodiments of FIGS. 1-3C, the outboard surface 24 forms an exterior aspect of the central portion 22 of the stanchion 14. The leading surface 26 forms the forward-most surface of the central portion 22 of the stanchion 14, and defines the first width “W₁” between the outboard surface 24 and the inboard surface 30. The trailing surface 28 forms the rearward-most surface of the central portion 22 of the stanchion 14. The trailing surface 28 defines the second width “W₂” between the outboard surface 24 and the inboard surface 30. In one aspect, both the first width “W₁” and the second width “W₂” are variable. For example, the first and second widths “W₁”, “W₂” may be greater at the roof surface 20 of the vehicle 12 than at the cross bar attachment portion 18. In one aspect, the second width “W₂” is smaller than the first width “W₁” of the leading surface 26. In another aspect, the second width “W₂” is greater than the first width “W₁” of the leading surface 26. When the first and second widths “W₁”, “W₂” are not equal to one another, the central portion 22 of the stanchion 14 has a generally tapering cross section.

The load securing portion 36 is integrally formed in the central portion 22 of the stanchion 14. The load securing portion 36 is positioned behind the leading surface 26, and is defined by a third recessed area 202 in the outboard surface 24, and a fourth recessed area 204 in the inboard surface 30. The third and fourth recessed areas 202, 204 are disposed behind the leading surface 26, and recessed from the smooth, curvilinear shape of the outboard surface 24 and the inboard surface 30. The load securing portion 36 includes attachment features 38 for receiving a fastener 40, such as a rope, cable, bungee, hook, clip, or the like.

In one aspect, the attachment features 38 include an inlet/outlet hole 206 defined by the third and fourth recessed areas 202, 204. The inlet/outlet hole 206 communicate via a curvilinear bore 207 located in an area behind the leading surface 26 of the central portion 22 of the stanchion 14. In one aspect, the inlet/outlet hole 206 is horizontally oriented in the load securing portion 36. In another aspect, the inlet/outlet hole 206 may be vertically oriented in the load securing portion 36. Thus, the curvilinear bore 207 traverses an internal aspect of the central portion 22 and so that fasteners 40 may be looped through the inlet/outlet hole 206 and used to secure a load to the vehicle 12. In one aspect, the inlet/outlet hole 206 faces the longitudinal axis of the vehicle 12.

The placement and orientation of the inlet/outlet hole 206 is optimized for ease of use, structural integrity, and low wind noise and turbulence characteristics. For example, when the vehicle 12 is in motion, there is a potential for the inlet/outlet hole 206 to resonate. That is, when air flows over the inlet/outlet hole 206, the inlet/outlet hole 206 may create audible noise, such as a whistling sound. In order to reduce the potential for whistling noises to emanate from the inlet/outlet hole 206, the inlet/outlet hole 206 is disposed within the third and fourth recessed areas 202, 204. More particularly, the leading surface 26 of the central portion 22 of the stanchion 14 directs airflow around the inlet/outlet hole 206 so that the potential for undesirable audible noise is decreased.

The roof rail system 200 further includes a fairing 209 that is substantially similar to the fairing of FIGS. 3A-3C, therefore like components are indicated by like reference numbers. The fairing 209 forms an aerodynamically efficient outer covering for the stanchion 14. As described above, when the first and second widths “W₁”, “W₂” of the stanchion 14 are not equal to one another, the central portion 22 of the stanchion 14 has a generally tapering cross section. Therefore, in order for the fairing 209 to engage with and contact both the outboard surface 24 and the inboard surface 30 of the central portion 22, the generally u-shaped fairing 209 has a similarly tapering cross-section from the front section 108 towards the rear of the vehicle 12.

In some aspects, to provide improved access to the inlet/outlet hole 206, the interior and exterior surfaces 102, 110 of the fairing 209 include protruding sections 208. The protruding sections 208 are generally smooth conical, or thimble-shaped, convex protrusions from that extend outward from the fairing 209 relative to the exterior surface 110. That is, the protruding sections 208 extend outward and away from the stanchion 14. Relative to the interior surface 102 of the fairing 209, the protruding sections 208 form concave areas or depressions. The protruding sections 208 extend from a nose portion 210 to a trailing portion 212. The nose portion 210 is located behind the front portion 116 of the fairing 209, and the trailing portion 212 is located at a rearmost edge of each of the interior and exterior surfaces 102, 110 of the fairing 209. That is, a protruding section 208 is located on each of the exterior portion 112, and the interior portion 114 of the fairing 209, and extends substantially horizontally from the nose portion 210 to the trailing portion 212. Furthermore, the protruding sections 208 are disposed in alignment with the inlet/outlet hole 206 and the third and fourth recessed areas 202, 204 so that an operator of the vehicle 12 may easily access the inlet/outlet hole 206 for attaching a fastener 40, such as a rope, cable, bungee, hook, clip, or the like. The smooth conical or thimble-shaped protruding sections 208 have a curvilinear shape that is aesthetically pleasing and aerodynamically optimized to reduce drag, wind-noise, and the like.

The roof rail attachment system 10, 200 of the present disclosure offers several advantages. These include ease of access for operators of the vehicle 12, as well as improved aerodynamics, noise, vibration, and harshness characteristics, and in particular, improved wind noise characteristics.

The description of the present disclosure is merely exemplary in nature and variations that do not depart from the gist of the present disclosure are intended to be within the scope of the present disclosure. Such variations are not to be regarded as a departure from the spirit and scope of the present disclosure.

The following is claimed:

1. A roof rail system for a motor vehicle comprises:
a stanchion extending away from a roof surface of the motor vehicle, the stanchion connected to the roof surface at a vehicle attachment portion, the stanchion having:
an outer surface facing outward from the motor vehicle, the outer surface connected to and extending from a leading surface to a trailing surface;
the leading surface oriented towards a front of the motor vehicle, and the trailing surface disposed opposite the leading surface and facing towards a rear of the motor vehicle;
an inner surface facing inward relative to the motor vehicle, the inner surface connected to and extending from the leading surface to the trailing surface, the inner surface disposed opposite the outer surface, and the inner surface having a first recessed portion with a load securing portion integrally formed therein,
wherein the load securing portion is disposed behind the leading surface relative to the front of the motor vehicle.

2. The roof rail system of claim 1 wherein the stanchion extends from the vehicle attachment portion to a cross bar attachment portion.

3. The roof rail system of claim 2 wherein the stanchion has a generally tapering cross section, wherein the stanchion has a local maximum cross sectional width proximate the leading surface, and a local minimum cross sectional width proximate the trailing surface.

4. The roof rail system of claim 3 wherein the stanchion has a generally tapering cross sectional width, wherein the stanchion has a local maximum cross sectional width at the vehicle attachment portion proximate the roof surface of the motor vehicle, and a local minimum cross sectional width proximate the cross bar attachment portion.

5. The roof rail system of claim 1 wherein each of the outer surface, the leading surface, and the trailing surface has a generally smooth, curvilinear shape.

6. The roof rail system of claim 1 wherein the stanchion is aerodynamically optimized to reduce aerodynamic drag, turbulence, vortices, and wind-noise.

7. The roof rail system of claim 1 wherein the load securing portion further comprises an inlet hole connected by a curvilinear bore to an outlet hole.

8. The roof rail system of claim 7 wherein the inlet hole is disposed within the first recessed portion in an area behind the leading surface, and the outlet hole is disposed in a second recessed portion positioned forward of the trailing surface.

9. The roof rail system of claim 7 wherein the inlet hole is oriented substantially vertically, and wherein the outlet hole faces substantially towards the rear of the motor vehicle, and the outlet hole is oriented substantially horizontally, and parallel to the roof surface.

10. The roof rail system of claim 7 wherein the inlet hole is oriented substantially horizontally and parallel to the roof surface, and wherein the outlet hole is oriented substantially horizontally and parallel to the roof surface.

11. The roof rail system of claim 7 wherein the inlet hole and the outlet hole are oriented between about 90° and 135° relative to one another.

12. The roof rail system of claim 1 further comprising a fairing forming an aerodynamically efficient outer covering for the inner surface, the outer surface, and the leading surface of the stanchion.

13. A roof rail system for a motor vehicle comprises:
a stanchion extending away from a roof surface of the motor vehicle, the stanchion connected to the roof surface at a vehicle attachment portion, and extending away from the roof surface to a cross bar attachment portion, the stanchion having:
an outer surface facing outward from the motor vehicle, the outer surface connected to and extending from a leading surface to a trailing surface;
the leading surface oriented towards a front of the motor vehicle, and the trailing surface disposed opposite the leading surface and facing towards a rear of the motor vehicle;
an inner surface facing inward relative to the motor vehicle, the inner surface connected to and extending from the leading surface to the trailing surface, the inner surface disposed opposite the outer surface, and the inner surface having a first recessed portion with a load securing portion integrally formed therein;
the stanchion having a fairing forming an aerodynamically efficient outer covering for the inner surface, the outer surface, and the leading surface of the stanchion,
wherein the stanchion has a generally tapering cross section with a local maximum cross sectional width proximate the leading surface, and a local minimum cross sectional width proximate the trailing surface, the stanchion having a local maximum cross sectional width at the vehicle attachment portion proximate the roof surface of the motor vehicle, and a local minimum cross sectional width proximate the cross bar attachment portion, the load securing portion is disposed behind the leading surface relative to the front of the motor vehicle.

14. The roof rail system of claim 11 wherein each of the outer surface, the leading surface, and the trailing surface has a generally smooth, curvilinear shape.

15. The roof rail system of claim 11 wherein the stanchion is aerodynamically optimized to reduce aerodynamic drag, turbulence, vortices, and wind-noise.

16. The roof rail system of claim 11 wherein the load securing portion further comprises an inlet hole connected by a curvilinear bore to an outlet hole.

17. The roof rail system of claim 14 wherein the inlet hole is disposed within the first recessed portion in an area behind the leading surface, and the outlet hole is disposed in a second recessed portion positioned forward of the trailing surface.

18. The roof rail system of claim 14 wherein the inlet hole is oriented substantially vertically and substantially perpendicular to the roof surface, and wherein the outlet hole faces substantially towards the rear of the motor vehicle, and the outlet hole is oriented substantially horizontally, and parallel to the roof surface.

19. The roof rail system of claim 14 wherein the inlet hole is oriented substantially horizontally and parallel to the roof surface, and wherein the outlet hole faces substantially laterally across the motor vehicle and is oriented substantially horizontally, and parallel to the roof surface.

20. A roof rail system for a motor vehicle comprises:
a plurality of aerodynamically optimized stanchions extending away from a roof surface of the motor vehicle, the stanchions connected to the roof surface at a vehicle attachment portion, and extending away from the roof surface to a cross bar attachment portion;
a plurality of cross bars attached to the plurality of stanchions at the cross bar attachment portion of each of the stanchions;
each of the stanchions having:
a substantially smooth, curvilinear outer surface facing outward from the motor vehicle, the outer surface connected to and extending from a substantially smooth, curvilinear leading surface to a substantially smooth, curvilinear trailing surface;
the leading surface oriented towards a front of the motor vehicle, and the trailing surface disposed opposite the leading surface and facing towards a rear of the motor vehicle;
an inner surface facing inward relative to the motor vehicle, the inner surface connected to and extending from the leading surface to the trailing surface, the inner surface disposed opposite the outer surface, and the inner surface having a first recessed portion with a load securing portion integrally formed therein,
the load securing portion having an inlet hole connected by a curvilinear bore to an outlet hole disposed in a second recessed portion of the inner surface, wherein the inlet hole is disposed within the first recessed portion in an area behind the leading surface, and the outlet hole is disposed in a second recessed portion positioned forward of the trailing surface;
wherein the stanchion has a generally tapering cross section with a local maximum cross sectional width proximate the leading surface, and a local minimum cross sectional width proximate the trailing surface, the stanchion having a local maximum cross sectional width at the vehicle attachment portion proximate the roof surface of the motor vehicle, and a local minimum cross sectional width proximate the cross bar attachment portion,
wherein the load securing portion is disposed behind the leading surface relative to the front of the motor vehicle; and
each of the stanchions having a fairing forming an aerodynamically efficient outer covering for the inner surface, the outer surface, and the leading surface of the stanchions.
